(19) United States
(12) Patent Application Publication
(10) Pub. No.: US 2025/0371553 A1
(43) Pub. Date: Dec. 4, 2025

(54) METHOD OF PROVIDING PERSONALIZED CUSTOMER INTERACTIONS WITH ADAPTIVE ARTIFICIAL INTELLIGENCE

(71) Applicant: BitHuman Inc, SAN FRANCISCO, CA (US)

(72) Inventors: Joseph P. Robinson, Salisbury, MA (US); Yun Fu, Newton, MA (US)

(73) Assignee: BitHuman Inc, SAN FRANCISCO, CA (US)

(21) Appl. No.: 18/732,610

(22) Filed: Jun. 3, 2024

(51) Int. Cl. G06Q 30/015; G06F 3/01; G06Q 30/0601; G06T 13/40; G06V 40/16; G06V 40/20; G10L 15/22; H04L 67/306

(52) U.S. Cl. CPC G06Q 30/015; G06F 3/013; G06Q 30/0631; G06T 13/40; G06V 40/174; G06V 40/20; G10L 15/22; H04L 67/306

(57) ABSTRACT

Embodiments of the present disclosure may include a method to provide personalized customer interactions via a set of virtual agents with biometrically adaptive retail artificial intelligence

### BACKGROUND OF THE INVENTION

Embodiments of the present disclosure may include a method to provide personalized customer interactions via a set of virtual agents with biometrically adaptive retail artificial intelligence.

### BRIEF SUMMARY

Embodiments of the present disclosure may include a method to provide personalized customer interactions via a set of virtual agents with biometrically adaptive retail artificial intelligence, the method including detecting, by one or more processors, a request for goods or services, by a user. In some embodiments, an artificial intelligence engine may be coupled to the one or more processors and a server.

In some embodiments, the artificial intelligence engine may be trained by human experts in the field. In some embodiments, the set of virtual agents may be configured to be displayed in LED/OLED displays, Android/iOS tablets, Laptops/PCs, kiosks, smartphones, or VR/AR goggles. In some embodiments, a set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon character. In some embodiments, the any of the set of virtual agents' gender, age and ethnicity may be determined by the artificial intelligence's analysis on input from the user. In some embodiments, the any of the set of virtual agents may be configured to be displayed in full body or half body portrait mode.

In some embodiments, the artificial intelligence engine may be configured for real-time speech recognition, speech-to-text generation, real-time dialog generation, text-to-speech generation, voice-driven animation, and human avatar generation. In some embodiments, the artificial intelligence engine may be configured to emulate different voices and use different languages.

Embodiments may also include detecting and tracking the user's face, gaze, and pose by a set of outward-facing cameras coupled to one or more processors. In some embodiments, a set of screens coupled to one or more processors may be configured to allow the user to interact with any of the set of virtual agents by hand. Embodiments may also include detecting the user's voice by a set of microphones coupled to one or more processors.

In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the any of the set of virtual agents.

In some embodiments, the any of the set of virtual agents may be configured to be created based on the appearance of a real human character, a popular cartoon/animated character. Embodiments may also include analyzing the user's profile from audio-visual information gathered by the set of outward-facing cameras and the set of microphones. In some embodiments, the user's profile includes the user's audio and facial characteristics.

Embodiments may also include selecting the user's profile based on matching audio and facial characteristics from a set of profiles in a customer database on the server. Embodiments may also include guiding and suggesting a set of items or services with real-time adjustable recommendations. In some embodiments, the set of virtual agents may be configured to adjust the recommendations by using real-time emotional intelligence with advanced emotion recognition technologies to interpret and respond to customers' emotions in real-time.

In some embodiments, the set of virtual agents may be configured to adjust guiding and suggesting responding to the user's facial expressions, tune expressions, sound, words with positive and negative tendencies. In some embodiments, the set of virtual agents may be configured to adjust the recommendations by integrating contextual factors. In some embodiments, the contextual factors may include weather and seasonal trends, a trending fashion, an approaching holiday, a viral video in social media platforms, a popular ball game.

In some embodiments, the contextual factors could global factors. In some embodiments, the contextual could be local factors. In some embodiments, the context factors could be individual store specific factors. Embodiments may also include providing options to help the user to make an ordering choice through the conversation. Embodiments may also include learning adaptively from each interaction and refining the understanding of the preferences and behaviors of the user for increasingly exact personalization.

Embodiments of the present disclosure may also include a method for providing personalized customer interactions via a set of virtual agents with biometrically adaptive retail artificial intelligence, the method including detecting, by one or more processors, a request for goods or customer services, by a user. In some embodiments, an artificial intelligence engine may be coupled to the one or more processors and a server.

In some embodiments, the artificial intelligence engine may be trained by human experts in the field. In some embodiments, the set of virtual agents may be configured to be displayed in LED/OLED displays, Android/iOS tablets, Laptops/PCs/kiosks, smartphones, or VR/AR goggles. In some embodiments, a set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon/animated character. In some embodiments, the any of the set of virtual agents' gender, age and ethnicity may be determined by the artificial intelligence's analysis on the sensor data captured by the system and input from the user.

In some embodiments, the any of the set of virtual agents may be configured to be displayed in full body or half body portrait mode. In some embodiments, the artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and in different languages. Embodiments may also include detecting and tracking the user's face, gaze and pose by a set of outward-facing cameras coupled to one or more processors. In some embodiments, a set of touch or voice-driven screens coupled to one or more processors may be configured to allow the user to interact with any of the set of virtual agents by hand or voice, respectively.

Embodiments may also include detecting the voice of the user by a set of microphones coupled to one or more processors. In some embodiments, the set of microphones may be connected to the one or more processors and speech-to-text may be running on the one or more processors. In some embodiments, the set of microphones may be enabled to be beamforming.

In some embodiments, the configuration for the pictures or voices of the user may be to be uploaded and processed either on a cloud server or in local or personal devices or hybrid configuration devices to analyze and create the any of the set of virtual agents. In some embodiments, the any of the set of virtual agents may be configured to be created based on the appearance of a real human character, a human realistic generated character, a popular cartoon character, a client's branded character, an animated generated character.

Embodiments may also include analyzing the user's profile from audio-visual information gathered by the set of outward-facing cameras and the set of microphones. In some embodiments, the user's profile includes the audio and facial characteristics of the user. Embodiments may also include selecting the user's profile based on matching audio and facial attributes from a set of profiles in a customer database on the server.

Embodiments may also include guiding and suggesting a set of items or services with real-time adjustable recommendations. In some embodiments, the set of virtual agents may be configured to adjust the recommendations by using real-time emotional intelligence with advanced emotion recognition technologies to interpret and respond to customers' emotions in real-time.

In some embodiments, the set of virtual agents may be configured to adjust guiding and suggesting responding to the user's facial expressions, tone expressions, sound, words of positive and negative sentiment. In some embodiments, the configuration of the set of virtual agents may be to adjust the recommendations by integrating contextual factors from the environment.

In some embodiments, the contextual factors may include weather and seasonal trends, a trending fashion, promotional deals, an approaching holiday and a viral video in social media platforms. Embodiments may also include providing options to help the user make an ordering choice through the conversation. Embodiments may also include learning adaptively from each interaction and refining understandings of preferences and behaviors of the user for increasingly exact personalization.

In some embodiments, the precise personalization to the user correlates. In some embodiments, the configuration for the set of virtual agents may be to adjust inventory of a set of products based on positive or negative sentiments of customers expressed towards the set of products. In some embodiments, the set of virtual agents may be configured to give out personalized promotions to the customers based on previous interactions fused with the current environmental and economic factors.

Embodiments of the present disclosure may also include a method to provide personalized customer interactions via a set of virtual agents with biometrically adaptive retail artificial intelligence, the method including detecting, by one or more processors, a request for goods or customer services, by a user. In some embodiments, an artificial intelligence engine may be coupled to one or more of the processors and a server.

In some embodiments, the artificial intelligence engine may be trained by human experts in the field. In some embodiments, the set of virtual agents may be configured to be displayed in LED/OLED displays, Android/iOS tablets, Laptops/PCs/kiosks, smartphones, or VR/AR goggles. In some embodiments, a set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon/animated character. In some embodiments, the any of the set of virtual agents' soft biometrics may be determined by the artificial intelligence's analysis on input from the user. In some embodiments, the any of the set of virtual agents may be configured to be displayed in full body or half body portrait mode.

In some embodiments, the artificial intelligence engine may be configured for real-time speech recognition, speech-to-text generation, real-time dialog generation, text-to-speech generation, voice-driven animation, and human avatar generation. In some embodiments, the artificial intelligence engine may be configured to emulate different voices and use different languages.

In some embodiments, the set of virtual agents' soft biometrics may be configured to may include gender, age and ethnicity. Embodiments may also include detecting and tracking the user's face, gaze, and pose by a set of outward-facing cameras coupled to one or more processors. In some embodiments, a set of touch or voice-driven screens coupled to one or more processors may be configured to allow the user to interact with any of the set of virtual agents by hand or voice.

Embodiments may also include detecting the user's voice by a set of microphones coupled to one or more processors. In some embodiments, the connection of the set of microphones may be to the one or more processors and speech-to-text may be running on the one or more processors. In some embodiments, the set of microphones may be enabled to be beamforming.

In some embodiments, the configuration of the pictures or voices of the user may be to be uploaded and processed either on a cloud server or in local or personal devices or both to analyze and create the any of the set of virtual agents. In some embodiments, any of the set of virtual agents may be configured to be created based on the appearance of a real or generated human character, a popular cartoon character, a generated animated.

Embodiments may also include analyzing the user's profile from audio-visual information gathered by the set of outward-facing cameras and the set of microphones. In some embodiments, the user's profile includes the user's audio and facial characteristics. Embodiments may also include selecting the user's profile based on matching audio and facial attributes from a set of profiles in a customer database on the server.

Embodiments may also include guiding and suggesting a set of items or services with real-time adjustable recommendations. In some embodiments, the set of virtual agents may be configured to adjust the recommendations by using real-time emotional intelligence with advanced emotion recognition technologies to interpret and respond to customers' emotions in real-time.

In some embodiments, we configure the set of virtual agents to adjust guiding and suggesting responding to the user's facial expressions, tune expressions, sound, words with positive and negative tendencies. In some embodiments, we configure the set of virtual agents to adjust the recommendations by integrating contextual factors. In some embodiments, the contextual factors may include weather and seasonal trends, a trending fashion, an approaching holiday and a viral video in social media platforms.

In some embodiments, the set of virtual agents may be configured to adjust the recommendations by using multimodal data fusion by blending biometric data with demographic and environmental factors. Embodiments may also include providing options to help the user make an ordering choice through the conversation. Embodiments may also include learning adaptively from each interaction and refine understandings of preferences and behaviors of the user for increasingly exact personalization.

In some embodiments, a correlation between the exact personalization and the user. In some embodiments, the set of virtual agents may be configured to adjust inventory of a set of products based on positive or negative sentiments of customers expressed towards the set of products. In some embodiments, the set of virtual agents may be configured to give out personalized promotions to the customers based on previous interactions.

In some embodiments, the configuration for the set of virtual agents may be to supply consistent and personalized experiences across various retail platforms. In some embodiments, the various retail platforms include physical stores and online portals. Embodiments may also include considering the history of the user in items purchased and sentiment to specific suggestions to learn from previous encounters to fuse with real-time cues in a weighted manner. Embodiments may also include considering store location, previous encounters with all users to fuse in decisions in a weighted manner. In some embodiments, information of the store location may include specific store location, regional locations and global locations.

### BRIEF DESCRIPTION OF THE FIGURES

FIG. 1A is a flowchart illustrating a method, according to some embodiments of the present disclosure.

FIG. 1B is a flowchart extending from FIG. 1A and further illustrating the method, according to some embodiments of the present disclosure.

FIG. 2A is a flowchart illustrating a method for providing personalized customer interactions, according to some embodiments of the present disclosure.

FIG. 2B is a flowchart extending from FIG. 2A and further illustrating the method for providing personalized customer interactions, according to some embodiments of the present disclosure.

FIG. 3A is a flowchart illustrating a method, according to some embodiments of the present disclosure.

FIG. 3B is a flowchart extending from FIG. 3A and further illustrating the method, according to some embodiments of the present disclosure.

FIG. 4 is a diagram showing an example of a method for providing personalized customer interactions, according to some embodiments of the present disclosure.

FIG. 5 is a diagram showing a second example of a method for providing personalized customer interactions, according to some embodiments of the present disclosure.

FIG. 6 is a diagram showing a third example of a method for providing personalized customer interactions, according to some embodiments of the present disclosure.

FIG. 7 is a diagram showing a fourth example of a method for providing personalized customer interactions, according to some embodiments of the present disclosure.

FIG. 8 is a diagram showing a fifth example of a method for providing personalized customer interactions, according to some embodiments of the present disclosure.

FIG. 9 is a diagram showing a sixth example of a method for providing personalized customer interactions, according to some embodiments of the present disclosure.

FIG. 10 is a diagram showing a seventh example of a method for providing personalized customer interactions, according to some embodiments of the present disclosure.

### DETAILED DESCRIPTION

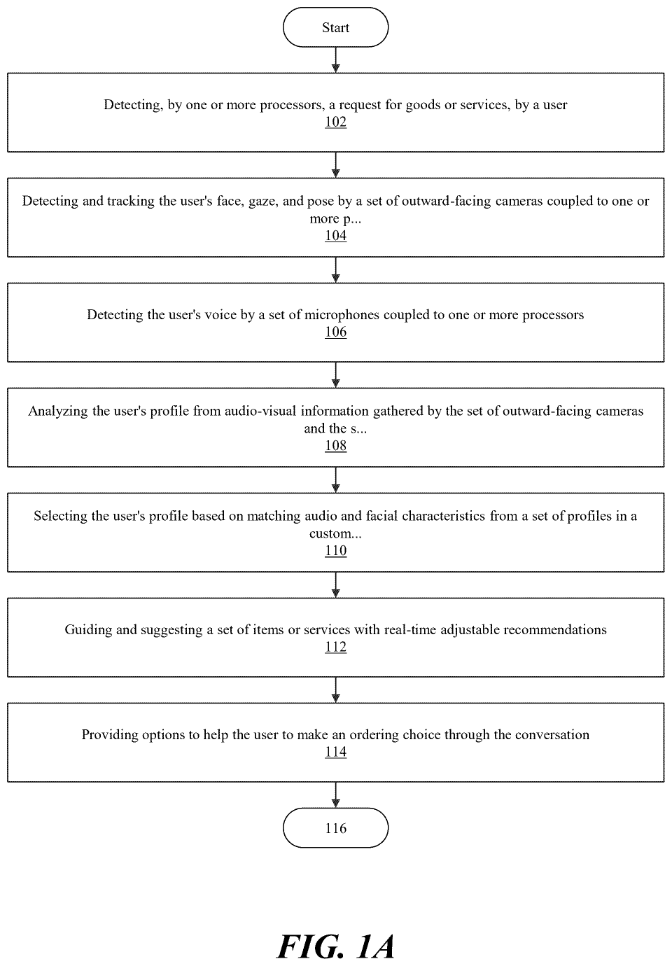

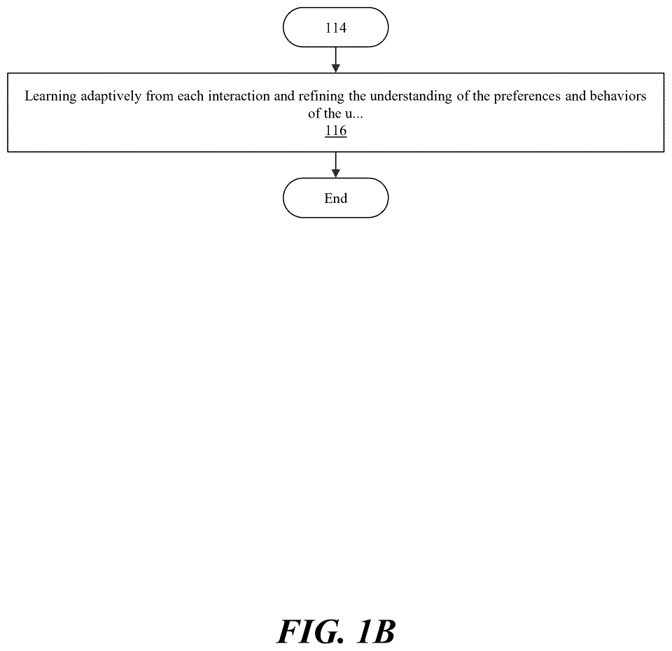

FIGS. 1A to 1B are flowcharts that describe a method, according to some embodiments of the present disclosure. In some embodiments, at 102, the method may include detecting, by one or more processors, a request for goods or services, by a user. At 104, the method may include detecting and tracking the user's face, gaze, and pose by a set of outward-facing cameras coupled to one or more processors. At 106, the method may include detecting the user's voice by a set of microphones coupled to one or more processors.

In some embodiments, at 108, the method may include analyzing the user's profile from audio-visual information gathered by the set of outward-facing cameras and the set of microphones. At 110, the method may include selecting the user's profile based on matching audio and facial characteristics from a set of profiles in a customer database on the server. At 112, the method may include guiding and suggesting a set of items or services with real-time adjustable recommendations. At 114, the method may include providing options to help the user to make an ordering choice through the conversation. At 116, the method may include learning adaptively from each interaction and refining the understanding of the preferences and behaviors of the user for increasingly exact personalization.

In some embodiments, an artificial intelligence engine may be coupled to the one or more processors and a server. The artificial intelligence engine may be trained by human experts in the field. The set of virtual agents may be configured to be displayed in LED/OLED displays, Android/iOS tablets, Laptops/PCs, kiosks, smartphones, or VR/AR goggles. A set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon character. The any of the set of virtual agents' gender, age and ethnicity may be determined by the artificial intelligence's analysis on input from the user. The any of the set of virtual agents may be configured to be displayed in full body or half body portrait mode.

In some embodiments, the artificial intelligence engine may be configured for real-time speech recognition, speech-to-text generation, real-time dialog generation, text-to-speech generation, voice-driven animation, and human avatar generation. The artificial intelligence engine may be configured to emulate different voices and use different languages. A set of screens coupled to one or more processors may be configured to allow the user to interact with any of the set of virtual agents by hand.

In some embodiments, the set of microphones may be connected to loudspeakers. The set of microphones may be enabled to be beamforming. Pictures or voices of the user may be configured to be uploaded and processed either on a cloud server or in local or personal devices to analyze and create the any of the set of virtual agents. The any of the set of virtual agents may be configured to be created based on the appearance of a real human character, a popular cartoon/animated character.

In some embodiments, the user's profile may include the user's audio and facial characteristics. The set of virtual agents may be configured to adjust the recommendations by using real-time emotional intelligence with advanced emotion recognition technologies to interpret and respond to customers' emotions in real-time. The set of virtual agents may be configured to adjust guiding and suggesting responding to the user's facial expressions, tune expressions, sound, words with positive and negative tendencies.

In some embodiments, the set of virtual agents may be configured to adjust the recommendations by integrating contextual factors. The contextual factors may comprise weather and seasonal trends, a trending fashion, an approaching holiday, a viral video in social media platforms, a popular ball game. The contextual factors could global factors. The contextual could be local factors. The context factors could be individual store specific factors.

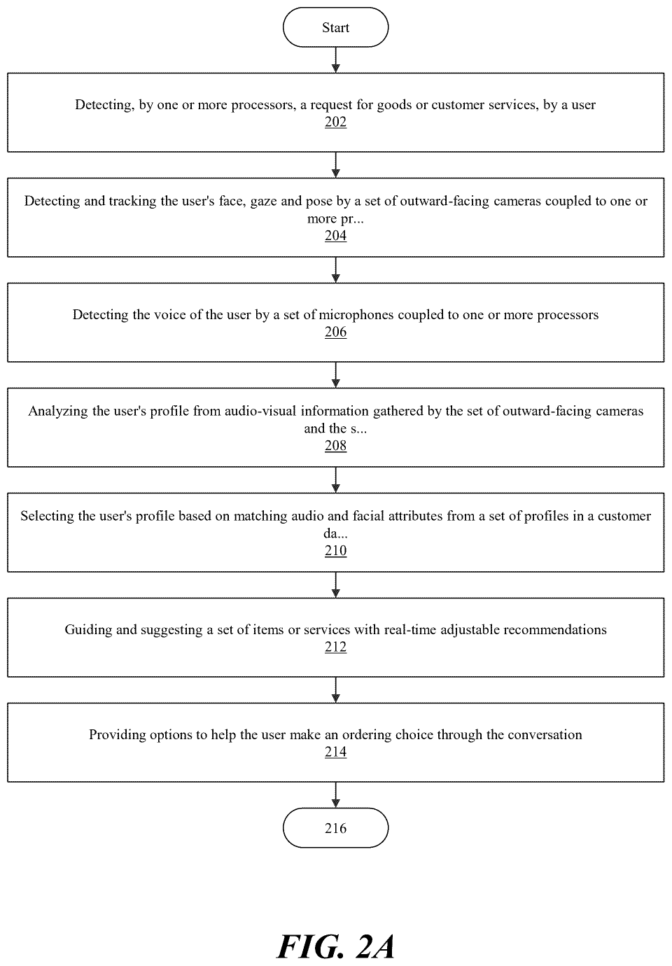

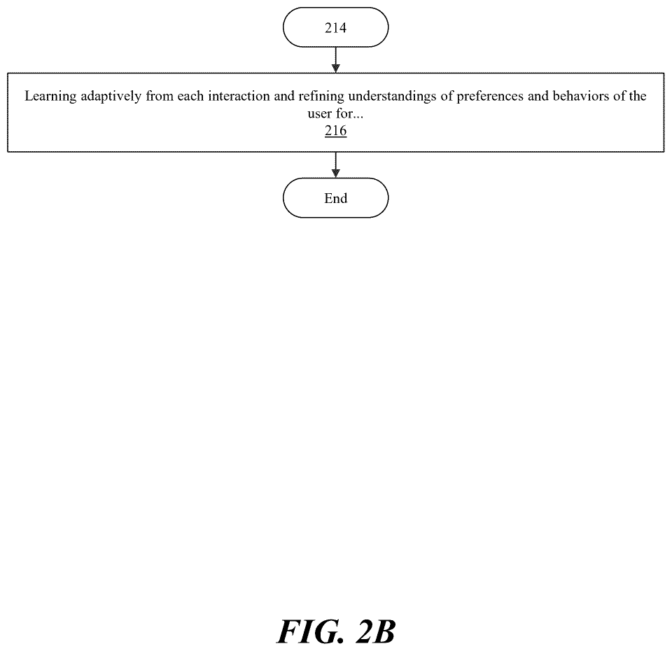

FIGS. 2A to 2B are flowcharts that describe a method for providing personalized customer interactions, according to some embodiments of the present disclosure. In some embodiments, at 202, the method may include detecting, by one or more processors, a request for goods or customer services, by a user. At 204, the method may include detecting and tracking the user's face, gaze and pose by a set of outward-facing cameras coupled to one or more processors. At 206, the method may include detecting the voice of the user by a set of microphones coupled to one or more processors.

In some embodiments, at 208, the method may include analyzing the user's profile from audio-visual information gathered by the set of outward-facing cameras and the set of microphones. At 210, the method may include selecting the user's profile based on matching audio and facial attributes from a set of profiles in a customer database on the server. At 212, the method may include guiding and suggesting a set of items or services with real-time adjustable recommendations. At 214, the method may include providing options to help the user make an ordering choice through the conversation. At 216, the method may include learning adaptively from each interaction and refining understandings of preferences and behaviors of the user for increasingly exact personalization.

In some embodiments, an artificial intelligence engine may be coupled to the one or more processors and a server. The artificial intelligence engine may be trained by human experts in the field. The set of virtual agents may be configured to be displayed in LED/OLED displays, Android/iOS tablets, Laptops/PCs/kiosks, smartphones, or VR/AR goggles. A set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon/animated character. The any of the set of virtual agents' gender, age and ethnicity may be determined by the artificial intelligence's analysis on the sensor data captured by the system and input from the user. The any of the set of virtual agents may be configured to be displayed in full body or half body portrait mode.

In some embodiments, the artificial intelligence engine may be configured for real-time speech recognition, speech-to-text generation, real-time dialog generation, text-to-speech generation, voice-driven animation, and human avatar generation. The artificial intelligence engine may be configured to emulate different voices and in different languages. A set of touch or voice-driven screens coupled to one or more processors may be configured to allow the user to interact with any of the set of virtual agents by hand or voice, respectively.

In some embodiments, the set of microphones may be connected to the one or more processors and speech-to-text may be running on the one or more processors. The set of microphones may be enabled to be beamforming. The configuration for the pictures or voices of the user may be to be uploaded and processed either on a cloud server or in local or personal devices or hybrid configuration devices to analyze and create the any of the set of virtual agents.

In some embodiments, the any of the set of virtual agents may be configured to be created based on the appearance of a real human character, a human realistic generated character, a popular cartoon character, a client's branded character, an animated generated character. The user's profile may include the audio and facial characteristics of the user. The set of virtual agents may be configured to adjust the recommendations by using real-time emotional intelligence with advanced emotion recognition technologies to interpret and respond to customers' emotions in real-time.

In some embodiments, the set of virtual agents may be configured to adjust guiding and suggesting responding to the user's facial expressions, tone expressions, sound, words of positive and negative sentiment. The configuration of the set of virtual agents may be to adjust the recommendations by integrating contextual factors from the environment. The contextual factors may comprise weather and seasonal trends, a trending fashion, promotional deals, an approaching holiday and a viral video in social media platforms.

In some embodiments, the precise personalization to the user may correlate. The configuration for the set of virtual agents may be to adjust inventory of a set of products based on positive or negative sentiments of customers expressed towards the set of products. The set of virtual agents may be configured to give out personalized promotions to the customers based on previous interactions fused with the current environmental and economic factors.

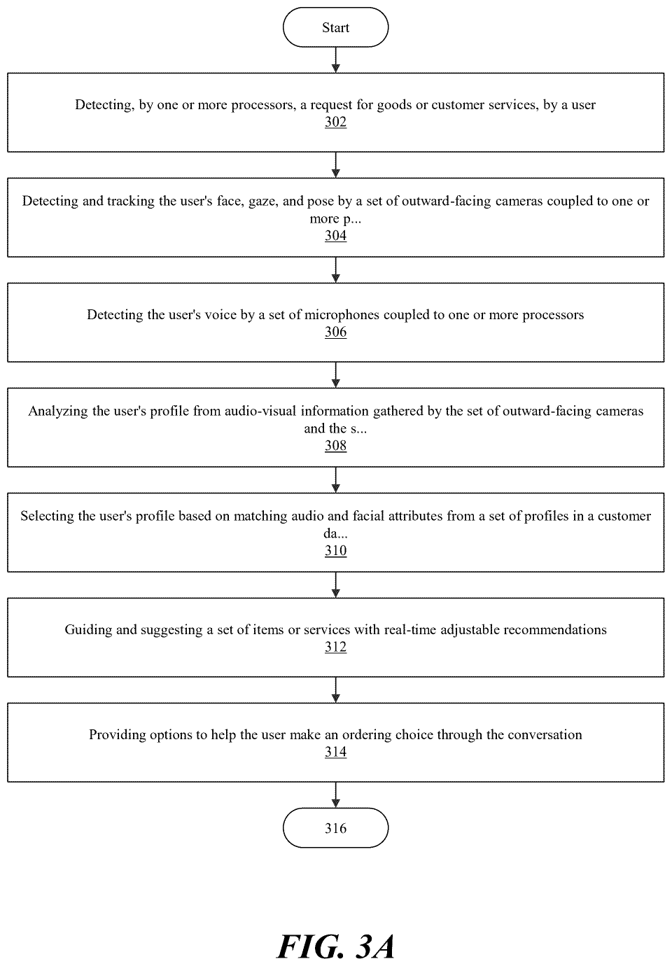

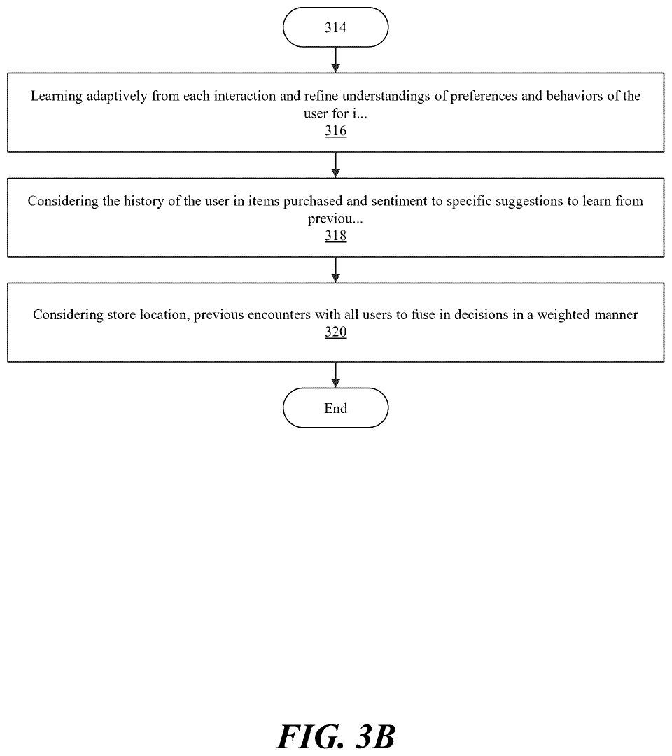

FIGS. 3A to 3B are flowcharts that describe a method, according to some embodiments of the present disclosure. In some embodiments, at 302, the method may include detecting, by one or more processors, a request for goods or customer services, by a user. At 304, the method may include detecting and tracking the user's face, gaze, and pose by a set of outward-facing cameras coupled to one or more processors. At 306, the method may include detecting the user's voice by a set of microphones coupled to one or more processors.

In some embodiments, at 308, the method may include analyzing the user's profile from audio-visual information gathered by the set of outward-facing cameras and the set of microphones. At 310, the method may include selecting the user's profile based on matching audio and facial attributes from a set of profiles in a customer database on the server. At 312, the method may include guiding and suggesting a set of items or services with real-time adjustable recommendations.

In some embodiments, at 314, the method may include providing options to help the user make an ordering choice through the conversation. At 316, the method may include learning adaptively from each interaction and refine understandings of preferences and behaviors of the user for increasingly exact personalization. At 318, the method may include considering the history of the user in items purchased and sentiment to specific suggestions to learn from previous encounters to fuse with real-time cues in a weighted manner. At 320, the method may include considering store location, previous encounters with all users to fuse in decisions in a weighted manner.

In some embodiments, an artificial intelligence engine may be coupled to one or more of the processors and a server. The artificial intelligence engine may be trained by human experts in the field. The set of virtual agents may be configured to be displayed in LED/OLED displays, Android/iOS tablets, Laptops/PCs/kiosks, smartphones, or VR/AR goggles. A set of multi-layer info panels coupled to the one or more processors may be configured to overlay graphics on top of any of the set of virtual agents.

In some embodiments, the any of the set of virtual agents may be configured to be displayed with an appearance of an actual human or a humanoid or a cartoon/animated character. The any of the set of virtual agents' soft biometrics may be determined by the artificial intelligence's analysis on input from the user. The any of the set of virtual agents may be configured to be displayed in full body or half body portrait mode.

In some embodiments, the artificial intelligence engine may be configured for real-time speech recognition, speech-to-text generation, real-time dialog generation, text-to-speech generation, voice-driven animation, and human avatar generation. The artificial intelligence engine may be configured to emulate different voices and use different languages. The set of virtual agents' soft biometrics may be configured to comprise gender, age and ethnicity.

In some embodiments, a set of touch or voice-driven screens coupled to one or more processors may be configured to allow the user to interact with any of the set of virtual agents by hand or voice. The connection of the set of microphones may be to the one or more processors and speech-to-text may be running on the one or more processors. The set of microphones may be enabled to be beamforming. The configuration of the pictures or voices of the user may be to be uploaded and processed either on a cloud server or in local or personal devices or both to analyze and create the any of the set of virtual agents.

In some embodiments, any of the set of virtual agents may be configured to be created based on the appearance of a real or generated human character, a popular cartoon character, a generated animated. The user's profile may include the user's audio and facial characteristics. The set of virtual agents may be configured to adjust the recommendations by using real-time emotional intelligence with advanced emotion recognition technologies to interpret and respond to customers' emotions in real-time.

In some embodiments, we configure the set of virtual agents to adjust guiding and suggesting responding to the user's facial expressions, tune expressions, sound, words with positive and negative tendencies. We configure the set of virtual agents to adjust the recommendations by integrating contextual factors. The contextual factors may comprise weather and seasonal trends, a trending fashion, an approaching holiday and a viral video in social media platforms.

In some embodiments, the set of virtual agents may be configured to adjust the recommendations by using multimodal data fusion by blending biometric data with demographic and environmental factors. A correlation between the exact personalization and the user. The set of virtual agents may be configured to adjust inventory of a set of products based on positive or negative sentiments of customers expressed towards the set of products.

In some embodiments, the set of virtual agents may be configured to give out personalized promotions to the customers based on previous interactions. The configuration for the set of virtual agents may be to supply consistent and personalized experiences across various retail platforms. The various retail platform may include physical stores and online portals. Information of the store location may comprise specific store location, regional locations and global locations.

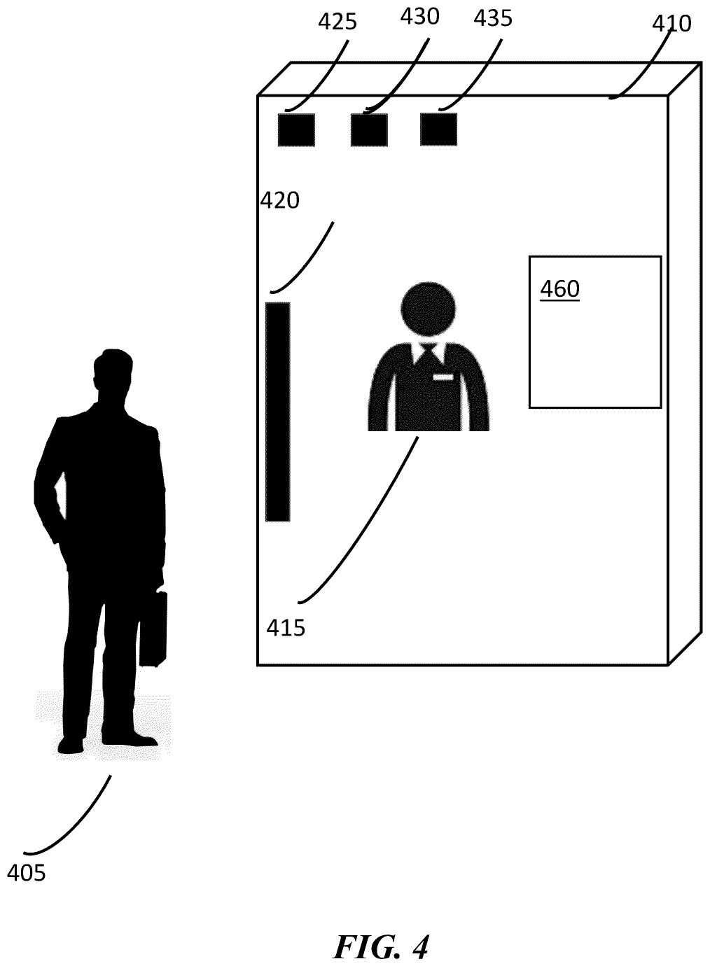

FIG. 4 is a diagram showing an example that describes the first example of a method for providing personalized customer interactions, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant with customer-facing duty 415 is active on the smart display 410. In some embodiments, a leading visual agent is guiding the artificial intelligence visual assistant with customer-facing duty 415 without the knowledge of the artificial intelligence visual assistant with customer-facing duty 415. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual agents as described in this example and the system and methods described in FIG. 1-3.

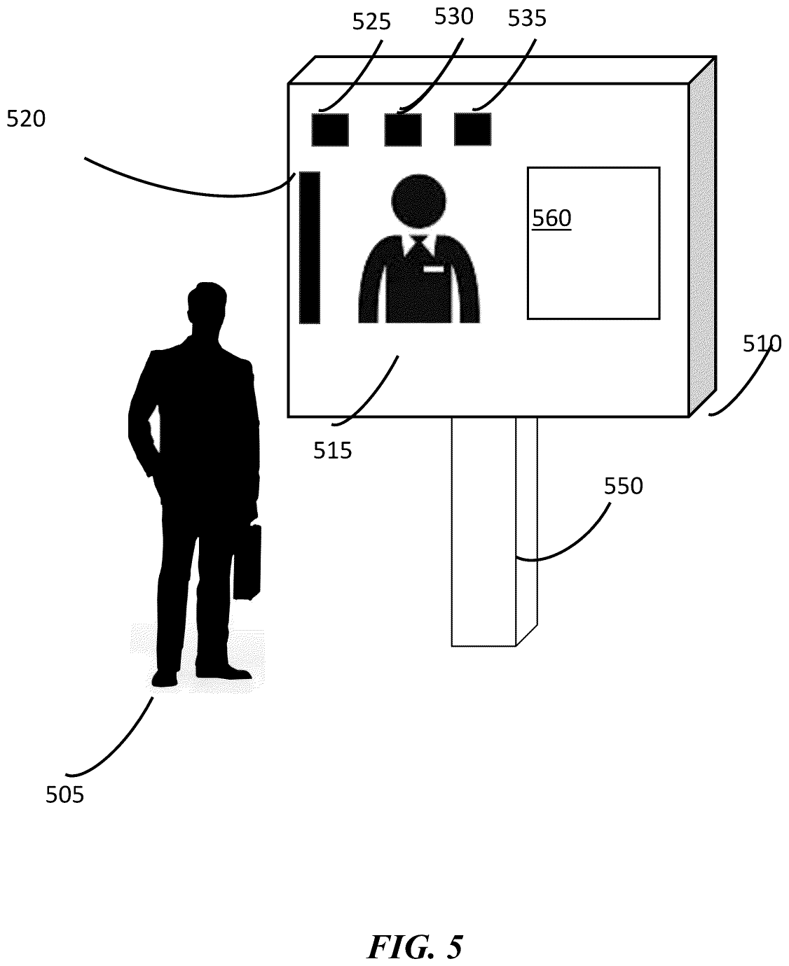

FIG. 5 is a diagram showing a second example of a method for providing personalized customer interactions, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant with customer-facing duty 515 is active on the smart display 510. In some embodiments, a leading visual agent is guiding the artificial intelligence visual assistant with customer-facing duty 515 without the knowledge of the artificial intelligence visual assistant with customer-facing duty 515. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user can interact with multiple AI visual assistants as described in this example and the system and methods described in FIG. 1-3.

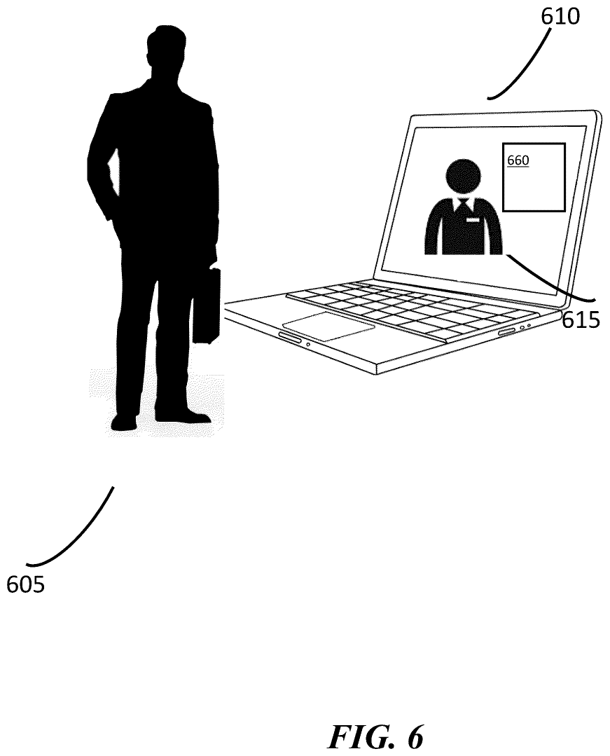

FIG. 6 is a diagram showing a third example of a method for providing personalized customer interactions, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 with customer-facing duty is active on the smart display 610. In some embodiments, a leading visual agent is guiding the artificial intelligence visual assistant with customer-facing duty 615 without the knowledge of the artificial intelligence visual assistant with customer-facing duty 615. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

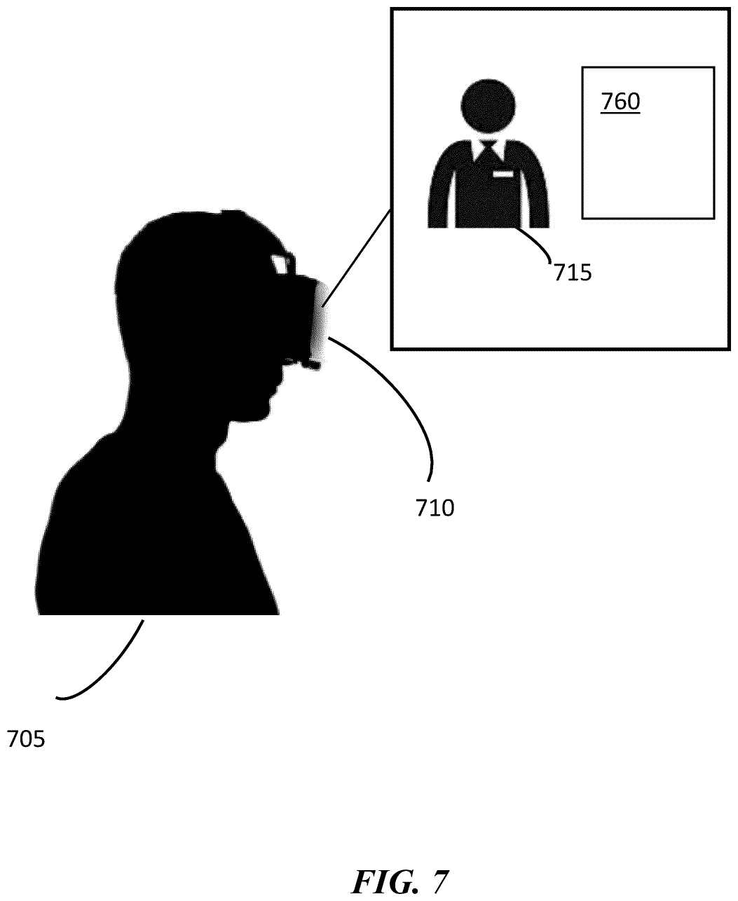

FIG. 7 is a diagram showing a fourth example of a method for providing personalized customer interactions, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 with customer-facing duty is active on the VR or AR device 710. In some embodiments, a leading visual agent is guiding the AI visual assistant with customer-facing duty 715 without the knowledge of the AI visual assistant with customer-facing duty 715. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service described in this paragraph. In some embodiments, other users can use this service described in this paragraph. In some embodiments, the user is able to interact with multiple AI visual assistants as described in this example and the system and methods described in FIG. 1-3.

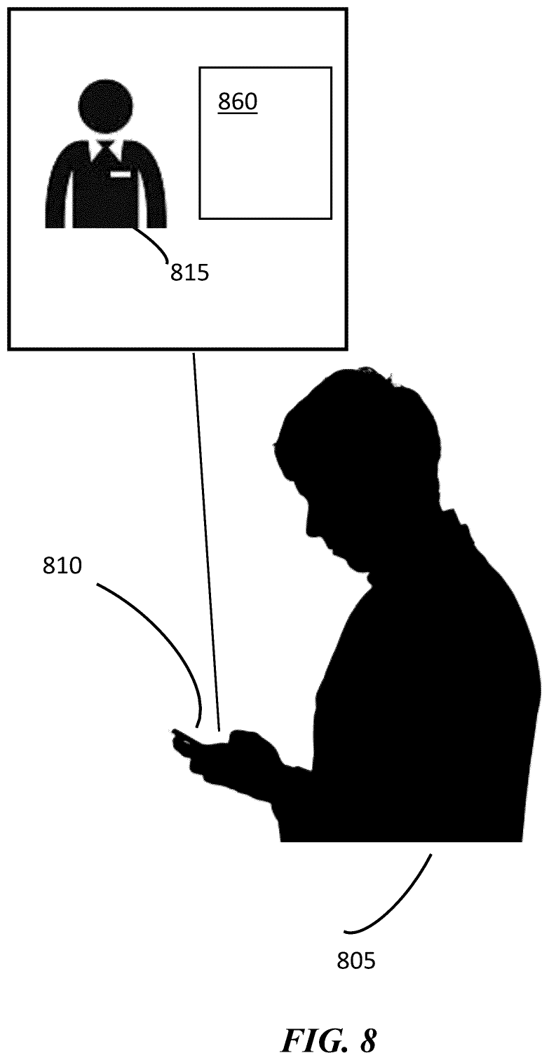

FIG. 8 is a diagram showing a fifth example of a method for providing personalized customer interactions, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 with customer-facing duty is active on the smartphone device 810. In some embodiments, a leading visual agent is guiding the AI visual assistant with customer-facing duty 815 without the knowledge of the AI visual assistant with customer-facing duty 815. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

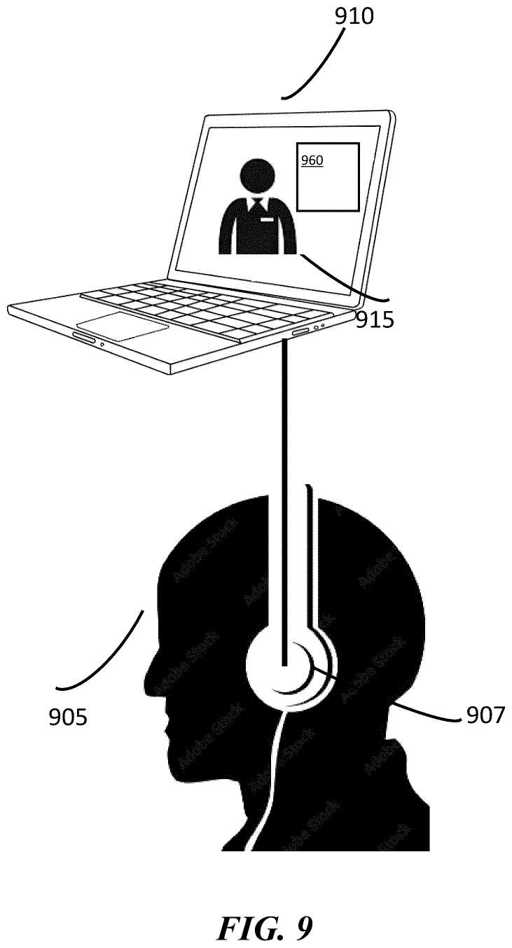

FIG. 9 is a diagram showing a sixth example of a method for providing personalized customer interactions, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 with customer-facing duty is active on the computer 910. In some embodiments, a leading visual agent is guiding the AI visual assistant with customer-facing duty 915 without the knowledge of the AI visual assistant with customer-facing duty 915. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

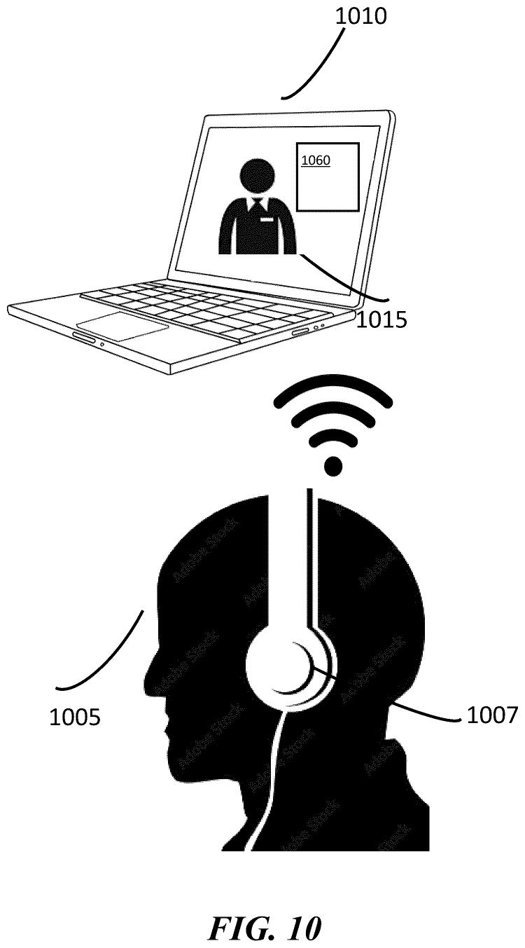

FIG. 10 is a diagram showing a seventh example of a method for providing personalized customer interactions, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 with customer-facing duty is active on the computer 1010. In some embodiments, a leading visual agent is guiding the AI visual assistant with customer-facing duty 1015 without the knowledge of the AI visual assistant with customer-facing duty 1015. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and the system and methods described in FIG. 1-3.

1. A method to provide personalized customer interactions via a set of virtual agents with biometrically adaptive retail artificial intelligence, the method comprising:
detecting, by one or more processors, a request for goods or services, by a user, wherein an artificial intelligence engine is coupled to the one or more processors and a server, wherein the artificial intelligence engine is trained by human experts in the field, wherein the set of virtual agents are configured to be displayed in LED/OLED displays, Android/iOS tablets, Laptops/PCs, kiosks, smartphones, or VR/AR goggles, wherein a set of multi-layer info panels coupled to the one or more processors are configured to overlay graphics on top of any of the set of virtual agents, wherein the any of the set of virtual agents is configured to be displayed with an appearance of an actual human or a humanoid or a cartoon character, wherein the any of the set of virtual agents' gender, age and ethnicity is determined by the artificial intelligence's analysis on input from the user, wherein the any of the set of virtual agents is configured to be displayed in full body or half body portrait mode, wherein the artificial intelligence engine is configured for real-time speech recognition, speech-to-text generation, real-time dialog generation, text-to-speech generation, voice-driven animation, and human avatar generation, wherein the artificial intelligence engine is configured to emulate different voices and use different languages;
detecting and tracking the user's face, gaze, and pose by a set of outward-facing cameras coupled to one or more processors, wherein a set of screens coupled to one or more processors is configured to allow the user to interact with any of the set of virtual agents by hand;
detecting the user's voice by a set of microphones coupled to one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the any of the set of virtual agents, wherein the any of the set of virtual agents is configured to be created based on the appearance of a real human character, a popular cartoon/animated character;
analyzing the user's profile from audio-visual information gathered by the set of outward-facing cameras and the set of microphones, wherein the user's profile includes the user's audio and facial characteristics;
selecting the user's profile based on matching audio and facial characteristics from a set of profiles in a customer database on the server;
guiding and suggesting a set of items or services with real-time adjustable recommendations, wherein the set of virtual agents is configured to adjust the recommendations by using real-time emotional intelligence with advanced emotion recognition technologies to interpret and respond to customers' emotions in real-time, wherein the set of virtual agents is configured to adjust guiding and suggesting responding to the user's facial expressions, tune expressions, sound, words with positive and negative tendencies, wherein the set of virtual agents is configured to adjust the recommendations by integrating contextual factors, wherein the contextual factors comprises weather and seasonal trends, a trending fashion, an approaching holiday, a viral video in social media platforms, a popular ball game, wherein the contextual factors could global factors, wherein the contextual could be local factors, wherein the context factors could be individual store specific factors;
providing options to help the user to make an ordering choice through the conversation; and
learning adaptively from each interaction and refining the understanding of the preferences and behaviors of the user for increasingly exact personalization.

2. A method for providing personalized customer interactions via a set of virtual agents with biometrically adaptive retail artificial intelligence, the method comprising:
detecting, by one or more processors, a request for goods or customer services, by a user, wherein an artificial intelligence engine is coupled to the one or more processors and a server, wherein the artificial intelligence engine is trained by human experts in the field, wherein the set of virtual agents are configured to be displayed in LED/OLED displays, Android/iOS tablets, Laptops/PCs/kiosks, smartphones, or VR/AR goggles, wherein a set of multi-layer info panels coupled to the one or more processors are configured to overlay graphics on top of any of the set of virtual agents, wherein the any of the set of virtual agents is configured to be displayed with an appearance of an actual human or a humanoid or a cartoon/animated character, wherein the any of the set of virtual agents' gender, age and ethnicity is determined by the artificial intelligence's analysis on the sensor data captured by the system and input from the user, wherein the any of the set of virtual agents is configured to be displayed in full body or half body portrait mode, wherein the artificial intelligence engine is configured for real-time speech recognition, speech-to-text generation, real-time dialog generation, text-to-speech generation, voice-driven animation, and human avatar generation, wherein the artificial intelligence engine is configured to emulate different voices and in different languages;
detecting and tracking the user's face, gaze and pose by a set of outward-facing cameras coupled to one or more processors, wherein a set of touch or voice-driven screens coupled to one or more processors is configured to allow the user to interact with any of the set of virtual agents by hand or voice, respectively;
detecting the voice of the user by a set of microphones coupled to one or more processors, wherein the set of microphones are connected to the one or more processors and speech-to-text is running on the one or more processors, wherein the set of microphones is enabled to be beamforming, wherein the configuration for the pictures or voices of the user is to be uploaded and processed either on a cloud server or in local or personal devices or hybrid configuration devices to analyze and create the any of the set of virtual agents, wherein the any of the set of virtual agents is configured to be created based on the appearance of a real human character, a human realistic generated character, a popular cartoon character, a client's branded character, an animated generated character;
analyzing the user's profile from audio-visual information gathered by the set of outward-facing cameras and the set of microphones, wherein the user's profile includes the audio and facial characteristics of the user;
selecting the user's profile based on matching audio and facial attributes from a set of profiles in a customer database on the server;
guiding and suggesting a set of items or services with real-time adjustable recommendations, wherein the set of virtual agents is configured to adjust the recommendations by using real-time emotional intelligence with advanced emotion recognition technologies to interpret and respond to customers' emotions in real-time, wherein the set of virtual agents is configured to adjust guiding and suggesting responding to the user's facial expressions, tone expressions, sound, words of positive and negative sentiment, wherein the configuration of the set of virtual agents is to adjust the recommendations by integrating contextual factors from the environment, wherein the contextual factors comprises weather and seasonal trends, a trending fashion, promotional deals, an approaching holiday and a viral video in social media platforms;
providing options to help the user make an ordering choice through the conversation; and
learning adaptively from each interaction and refining understandings of preferences and behaviors of the user for increasingly exact personalization, wherein the precise personalization to the user correlates, wherein the configuration for the set of virtual agents is to adjust inventory of a set of products based on positive or negative sentiments of customers expressed towards the set of products, wherein the set of virtual agents are configured to give out personalized promotions to the customers based on previous interactions fused with the current environmental and economic factors.

3. A method to provide personalized customer interactions via a set of virtual agents with biometrically adaptive retail artificial intelligence, the method comprising:
detecting, by one or more processors, a request for goods or customer services, by a user, wherein an artificial intelligence engine is coupled to one or more of the processors and a server, wherein the artificial intelligence engine is trained by human experts in the field, wherein the set of virtual agents are configured to be displayed in LED/OLED displays, Android/iOS tablets, Laptops/PCs/kiosks, smartphones, or VR/AR goggles, wherein a set of multi-layer info panels coupled to the one or more processors are configured to overlay graphics on top of any of the set of virtual agents, wherein the any of the set of virtual agents is configured to be displayed with an appearance of an actual human or a humanoid or a cartoon/animated character, wherein the any of the set of virtual agents' soft biometrics is determined by the artificial intelligence's analysis on input from the user, wherein the any of the set of virtual agents is configured to be displayed in full body or half body portrait mode, wherein the artificial intelligence engine is configured for real-time speech recognition, speech-to-text generation, real-time dialog generation, text-to-speech generation, voice-driven animation, and human avatar generation, wherein the artificial intelligence engine is configured to emulate different voices and use different languages, wherein the set of virtual agents' soft biometrics are configured to comprise gender, age and ethnicity;
detecting and tracking the user's face, gaze, and pose by a set of outward-facing cameras coupled to one or more processors, wherein a set of touch or voice-driven screens coupled to one or more processors is configured to allow the user to interact with any of the set of virtual agents by hand or voice;
detecting the user's voice by a set of microphones coupled to one or more processors, wherein the connection of the set of microphones is to the one or more processors and speech-to-text is running on the one or more processors wherein the set of microphones is enabled to be beamforming, wherein the configuration of the pictures or voices of the user are to be uploaded and processed either on a cloud server or in local or personal devices or both to analyze and create the any of the set of virtual agents, wherein any of the set of virtual agents is configured to be created based on the appearance of a real or generated human character, a popular cartoon character, a generated animated;
analyzing the user's profile from audio-visual information gathered by the set of outward-facing cameras and the set of microphones, wherein the user's profile includes the user's audio and facial characteristics;
selecting the user's profile based on matching audio and facial attributes from a set of profiles in a customer database on the server;
guiding and suggesting a set of items or services with real-time adjustable recommendations, wherein the set of virtual agents is configured to adjust the recommendations by using real-time emotional intelligence with advanced emotion recognition technologies to interpret and respond to customers' emotions in real-time, wherein we configure the set of virtual agents to adjust guiding and suggesting responding to the user's facial expressions, tune expressions, sound, words with positive and negative tendencies, wherein we configure the set of virtual agents to adjust the recommendations by integrating contextual factors, wherein the contextual factors comprises weather and seasonal trends, a trending fashion, an approaching holiday and a viral video in social media platforms, wherein the set of virtual agents is configured to adjust the recommendations by using multimodal data fusion by blending biometric data with demographic and environmental factors;
providing options to help the user make an ordering choice through the conversation;
learning adaptively from each interaction and refine understandings of preferences and behaviors of the user for increasingly exact personalization, wherein a correlation between the exact personalization and the user, wherein the set of virtual agents are configured to adjust inventory of a set of products based on positive or negative sentiments of customers expressed towards the set of products, wherein the set of virtual agents are configured to give out personalized promotions to the customers based on previous interactions, wherein the configuration for the set of virtual agents is to supply consistent and personalized experiences across various retail platforms, wherein the various retail platform includes physical stores and online portals;
considering the history of the user in items purchased and sentiment to specific suggestions to learn from previous encounters to fuse with real-time cues in a weighted manner; and
considering store location, previous encounters with all users to fuse in decisions in a weighted manner, wherein information of the store location comprises specific store location, regional locations and global locations.
